(19) United States
(12) Patent Application Publication
(10) Pub. No.: US 2016/0277259 A1
(43) Pub. Date: Sep. 22, 2016

(54) TRAFFIC QUALITY ANALYSIS METHOD AND APPARATUS

(71) Applicant: BEIJING GRIDSUM TECHNOLOGY CO., LTD., Beijing (CN)

(72) Inventors: Guosheng QI, Beijing (CN); Yongjian HUANG, Beijing (CN); Chong WU, Beijing (CN); Jibin YANG, Beijing (CN); Feng LI, Beijing (CN)

(73) Assignee: BEIJING GRIDSUM TECHNOLOGY CO., LTD., Beijing (CN)

(21) Appl. No.: 15/037,444

(22) PCT Filed: Nov. 7, 2014
(86) PCT No.: PCT/CN2014/090632

§ 371 Date: May 18, 2016

(30) Foreign Application Priority Data
Nov. 18, 2013 (CN) 201310577180.5

(51) Int. Cl. H04L 12/26; G06F 17/30; H04L 29/08

(52) U.S. Cl. CPC H04L 43/062; H04L 43/045; H04L 67/02; G06F 17/30887

(57) ABSTRACT

The disclosure discloses a traffic quality analysis method and apparatus. The method includes that: traffic data of a target website is acquired; a webpage Uniform Resource Locator (URL) is extracted from the traffic data; a weight of the webpage URL is determined; and in accordance with pre-set dimension data, the traffic data and the weight, the traffic quality of the target website is determined. By means of the disclosure, the problem in the traditional art that website traffic cannot be accurately analyzed by using traffic data is solved, thereby achieving the effect of clearly, visually and accurately reflecting the degree of strength and weakness of the website traffic.

### TECHNICAL FIELD

The disclosure relates to the field of traffic data processing, and in particular to a traffic quality analysis method and apparatus.

### BACKGROUND

The analysis of traffic data in the traditional art is generally limited to the analysis of a traffic count namely a traffic quantity. For example, traffic data of a homepage of an e-commerce website is often maximal. However, a user often views the homepage aimlessly, and the user is often really interested in sub-pages. By means of a traffic analysis method in the traditional art, only the traffic quantity is calculated, which may obtain an analysis result showing that the traffic data of the homepage is maximal and traffic data of a secondary page or a tertiary page may be second maximal. Accordingly, it is analyzed that the homepage is most popular, and an owner of the e-commerce website will truly gain a benefit after the user views a specific product page and pays for an order. There out, it cannot accurate to obtain the traffic status of the website by the traffic quantity.

An effective solution is not proposed currently for the problem in the traditional art that website traffic cannot be accurately analyzed by using traffic data.

### SUMMARY

An effective solution is not proposed currently for the problem in the traditional art that website traffic cannot be accurately analyzed by using traffic data. For this, the disclosure mainly aims to provide a traffic quality analysis method and apparatus, which are intended to solve the problem.

In order to achieve the aim, according to one aspect of the disclosure, a traffic quality analysis method is provided, which may include that: traffic data of a target website is acquired; a webpage Uniform Resource Locator (URL) is extracted from the traffic data; a weight of the webpage URL is determined; and in accordance with pre-set dimension data, the traffic data and the weight, the traffic quality of the target website is determined.

Furthermore, the step that the weight of the webpage URL is determined may include that: a pre-set weight value corresponding to the webpage URL is extracted from a pre-set weight database; and the pre-set weight value is assigned to the webpage URL to obtain the weight.

Furthermore, the step that the traffic quality of the target website is determined in accordance with the pre-set dimension data, the traffic data and the weight may include that: traffic sub-data corresponding to the dimension data is extracted from the traffic data; and a traffic quality score is calculated according to the traffic sub-data and the weight.

Furthermore, the step that the traffic quality score is calculated according to the traffic sub-data and the weight may include that: a webpage traffic quality score F of each webpage URL is calculated by using a formula: F=Q*S, where, Q is the weight, and S is the traffic sub-data; and the webpage traffic quality scores are sumd to obtain the traffic quality score of the target website.

Furthermore, after the traffic quality of the target website is determined in accordance with the pre-set dimension data, the traffic data and the weight, the traffic quality analysis method may further include that: the traffic quality corresponding to different dimension data is compared to generate a traffic quality analysis report.

In order to achieve the aim, according to one aspect of the disclosure, a traffic quality analysis apparatus is provided, which may include: an acquisition module, configured to acquire traffic data of a target website; an extraction module, configured to extract a webpage URL from the traffic data; a weight determination module, configured to determine a weight of the webpage URL; and a quality acquisition module, configured to determine the traffic quality of the target website in accordance with pre-set dimension data, the traffic data and the weight.

Furthermore, the weight determination module may include: a weight extraction module, configured to extract a pre-set weight value corresponding to the webpage URL from a pre-set weight database; and an assignment module, configured to assign the pre-set weight value to the webpage URL to obtain the weight.

Furthermore, the quality acquisition module may include: a data extraction module, configured to extract traffic sub-data corresponding to the dimension data from the traffic data; and a calculation module, configured to calculate a traffic quality score according to the traffic sub-data and the weight.

Furthermore, the calculation module may include: a first calculation sub-module, configured to calculate a webpage traffic quality score F of each webpage URL by using a formula: F=Q*S, where, Q is the weight, and S is the traffic sub-data; and a second calculation sub-module, configured to sum the webpage traffic quality scores to obtain the traffic quality score of the target website.

Furthermore, the traffic quality analysis apparatus may further include: a comparison module, configured to compare the traffic quality corresponding to different dimension data to generate a traffic quality analysis report.

By means of the disclosure, the weight of the webpage URL in the target website is determined, and the traffic quality of the website is determined according to the pre-set dimension data, the traffic data and the weight. Different weight settings are made for different types and different levels of page URLs of the website instead of evaluation of strength and weakness of website traffic only in accordance with a traffic quantity, and different traffic quality scores are acquired accordingly. Thus, more effective traffic is enabled to have a higher traffic quality score, thereby solving the problem in the traditional art that the website traffic cannot be accurately analyzed by using traffic data, and achieving the effect of clearly, visually and accurately reflecting the degree of strength and weakness of the website traffic.

### BRIEF DESCRIPTION OF THE DRAWINGS

The drawings described here are intended to provide further understanding of the disclosure, and form a part of the disclosure. The schematic embodiments and descriptions of the disclosure are intended to explain the disclosure, and do not form improper limits to the disclosure. In the drawings:

FIG. 1 is a diagram of a traffic quality analysis apparatus according to an embodiment of the disclosure; and

FIG. 2 is a flowchart of a traffic quality analysis method according to an embodiment of the disclosure.

### DETAILED DESCRIPTION OF THE EMBODIMENTS

It is important to note that the embodiments of the disclosure and the characteristics in the embodiments can be combined under the condition of no conflicts. The disclosure is described below with reference to the drawings and the embodiments in detail.

Firstly, some phrases or terms occurring in a process of describing the embodiments of the disclosure are applicable to being explained as follows.

Traffic quality is data for evaluating the strength/weakness and quantity of website traffic from different perspectives with respect to a traffic quantity.

In order to make those skilled in the art better understand the solutions of the disclosure, the technical solutions in the embodiments of the disclosure are clearly and completely described below with reference to the drawings in the embodiments of the disclosure. Obviously, the described embodiments are only a part of the embodiments of the disclosure, not all of the embodiments. On the basis of the embodiments of the disclosure, all other embodiments obtained on the premise of no creative work of those skilled in the art shall fall within the protection scope of the disclosure.

It is important to note that the description and claims of the disclosure and terms “first”, “second” and the like in the drawings are intended to distinguish similar objects, and do not need to describe a specific sequence or a precedence order. It should be understood that used data can be exchanged under appropriate conditions, in order that the embodiments of the disclosure described here can be implemented in a sequence except sequences graphically shown or described here. In addition, terms “include” and “have” and any inflexions thereof are intended to cover non-exclusive inclusions. For example, processes, methods, systems, products or devices containing a series of steps or units do not need to clearly show those steps or units, and can include other inherent steps or units of these processes, methods, products or devices, which are not clearly shown.

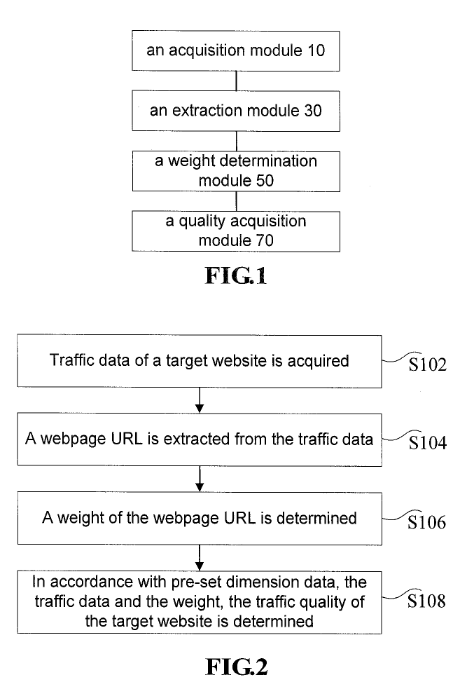

FIG. 1 is a diagram of a traffic quality analysis apparatus according to an embodiment of the disclosure. As shown in FIG. 1, the apparatus may include: an acquisition module 10, configured to acquire traffic data of a target website; an extraction module 30, configured to extract a webpage URL from the traffic data; a weight determination module 50, configured to determine a weight of the webpage URL; and a quality acquisition module 70, configured to determine the traffic quality of the target website in accordance with pre-set dimension data, the traffic data and the weight.

By means of the disclosure, the weight of the webpage URL in the target website is determined, and the traffic quality of the website is determined according to the pre-set dimension data, the traffic data and the weight. Different weight settings are made for different types and different levels of page URLs of the website instead of evaluation of strength and weakness of website traffic only in accordance with a traffic quantity, and different traffic quality scores are acquired accordingly. Thus, more effective traffic is enabled to have a higher traffic quality score, thereby solving the problem in the traditional art that the website traffic cannot be accurately analyzed by using traffic data, and achieving the effect of clearly, visually and accurately reflecting the degree of strength and weakness of the website traffic.

According to the embodiment of the disclosure, the weight determination module includes: a weight extraction module, configured to extract a pre-set weight value corresponding to the webpage URL from a pre-set weight database; and an assignment module, configured to assign the pre-set weight value to the webpage URL to obtain the weight.

Wherein, the pre-set weight value in the embodiment can be obtained according to an empirical value which is saved in the pre-set weight database.

For example, the target website is an e-commerce website, data of a homepage is often maximal, but the quality is lowest, and a visitor often views the homepage only aimlessly; the quality of a specific product page is slightly high, and it is shown that the visitor becomes moderately interested in this product; and the quality of a payment confirmation page is highest. This represents a real income, so a pre-set weight value of the homepage is 1, a pre-set weight value of the specific product page is 5, and a pre-set weight value of the payment confirmation page is 20.

In the embodiment of the disclosure, the quality acquisition module may include: a data extraction module, configured to extract traffic sub-data corresponding to the dimension data from the traffic data; and a calculation module, configured to calculate a traffic quality score according to the traffic sub-data and the weight.

In the embodiment of the disclosure, dimensions may be regional dimensions (specifically divided into Beijing, Shanghai and other cities for instance), operating system dimensions (Windows XP, Win7, Win8 and the like for instance) of a user device viewing the target website, and browser dimensions (IE8, IE9, Firefox, Chrome and the like for instance) for viewing the target website, or may be a combination of any some dimensions. For example, the traffic data is subdivided by simultaneously using a region and an operating system. Extension and combination can be carried out according to an actual analysis requirement specifically.

Specifically, the calculation module includes: a first calculation sub-module, configured to calculate a webpage traffic quality score F of each webpage URL by using a formula: F=Q*S, where, Q is the weight, and S is the traffic sub-data; and a second calculation sub-module, configured to sum the webpage traffic quality scores to obtain the traffic quality score of the target website.

According to the embodiment of the disclosure, the traffic quality analysis apparatus further includes: a comparison module, configured to compare the traffic quality corresponding to different dimension data to generate a traffic quality analysis report.

In the illustration, after the traffic quality of different dates is acquired, the traffic quality can be analyzed and compared. Specifically, the sizes of traffic data corresponding to different dimension data are compared to obtain a comparison result, an association relation is established among the comparison result, the dimension data, a traffic data volume, the traffic quality and the page URL, and the data and the association relation thereof are saved in a data table to generate the traffic quality analysis report.

In the embodiment of the disclosure, the traffic quality can be taken as a comparison reference for multiple dates or traffic conditions of all dimensions of different traffic sources, different regions and the like.

For example, a weight value of a URL1 is 1, a weight value of a URL2 is 10, and a weight value of a URL3 is 20. By means of the dimensions of the region (which may be a province specifically), it is analyzed that: if the traffic quantity of an access URL1 of Beijing is 100, the traffic quantity of a URL2 is 10 and the traffic quantity of a URL3 is 5, a traffic quality score of Beijing is calculated to be 300; and if the traffic quantity of an access URL1 of Shanghai is 10, the traffic quantity of a URL2 is 20 and the traffic quantity of a URL3 is 10, a traffic quality score of Shanghai is calculated to be 410.

Then, the traffic quality score of Beijing and the traffic quality score of Shanghai are compared to obtain a conclusion that the traffic quality of Shanghai is higher than that of Beijing. However, the method in the traditional art is adopted to obtain a conclusion that the access traffic of Beijing is 115 and the access traffic of Shanghai is 40, and therefore the analysis is inaccurate.

Specifically, traffic data of each webpage in a website can be collected by using a javascript and is stored in a form of a log file. Wherein, the traffic data contains each page URL of the website; optionally, the traffic data in the embodiment may further include: a traffic quantity and a weight value of each page URL; and furthermore, the traffic data may further include the dimension data, the dimension data may be one of regional dimensions, operating system dimensions of a user device viewing a target website, and browser dimensions for viewing the target website, or may be a combination of some dimensions, and extension and combination can be carried out according to an actual analysis requirement specifically.

The regional dimensions can be specifically divided into Beijing, Shanghai and other cities; the operating system dimensions of the user device can include Windows XP, Win7, Win8 and the like; and the browser dimensions include IE8, IE9, Firefox, Chrome and the like.

By means of the embodiment, if the regional dimensions are analyzed, it is necessary to access an Internet Protocol (IP) address of a URL; if the operating system dimensions are analyzed, an operating system and a version number of the user device are needed; and if the browser dimensions are analyzed, a browser name and a version number are needed.

In the embodiment, assignment is carried out (namely the weight is determined) according to an importance difference between important URLs. Specifically, different target websites have different manual settings, a key page to which a site owner most expects a user to have access is found by carrying out service analysis on the target website, and higher weight values can be assigned to these pages; or by analyzing historical data of the target website, a relevancy between each page and a service target (such as an order quantity or an order amount), and a high value is assigned to a page having high relevancy.

The weight of the page URL in the embodiment can be pre-saved in the pre-set weight database.

After the weight of the page URL is determined, the traffic quality can be judged according to different dimensions.

FIG. 2 is a flowchart of a traffic quality analysis method according to an embodiment of the disclosure. As shown in FIG. 2, the method includes the steps as follows.

Step S102: Traffic data of a target website is acquired.

Step S104: A webpage URL is extracted from the traffic data.

Step S106: A weight of the webpage URL is determined.

Step S108: In accordance with pre-set dimension data, the traffic data and the weight, the traffic quality of the target website is determined.

By means of the disclosure, the weight of the webpage URL in the target website is determined, and the traffic quality of the website is determined according to the pre-set dimension data, the traffic data and the weight. Different weight settings are made for different types and different levels of page URLs of the website instead of evaluation of strength and weakness of website traffic only in accordance with a traffic quantity, and different traffic quality scores are acquired accordingly. Thus, more effective traffic is enabled to have a higher traffic quality score, thereby solving the problem in the traditional art that the website traffic cannot be accurately analyzed by using traffic data, and achieving the effect of clearly, visually and accurately reflecting the degree of strength and weakness of the website traffic.

In the embodiment of the disclosure, the step that the weight of the webpage URL is determined may include: a pre-set weight value corresponding to the webpage URL is extracted from a pre-set weight database; and the pre-set weight value is assigned to the webpage URL to obtain the weight.

Wherein, the pre-set weight value in the embodiment can be obtained according to an empirical value which is saved in the pre-set weight database.

For example, the target website is an e-commerce website, data of a homepage is often maximal, but the quality is lowest, and a visitor often views the homepage only aimlessly; the quality of a specific product page is slightly high, and it is shown that the visitor becomes moderately interested in this product; and the quality of a payment confirmation page is highest. This represents a real income, so a pre-set weight value of the homepage can be set as 1, a pre-set weight value of the specific product page can be set as 5, and a pre-set weight value of the payment confirmation page can be set as 20.

In the embodiment of the disclosure, the step that the traffic quality of the target website is determined in accordance with the pre-set dimension data, the traffic data and the weight may include that: traffic sub-data corresponding to the dimension data is extracted from the traffic data; and a traffic quality score is calculated according to the traffic sub-data and the weight.

In the embodiment of the disclosure, dimensions may be regional dimensions (specifically divided into Beijing, Shanghai and other cities for instance), operating system dimensions (Windows XP, Win7, Win8 and the like for instance) of a user device viewing the target website, and browser dimensions (IE8, IE9, Firefox, Chrome and the like for instance) for viewing the target website, or may be a combination of any some dimensions. For example, the traffic data is subdivided by simultaneously using a region and an operating system. Extension and combination can be carried out according to an actual analysis requirement specifically.

Specifically, the step that the traffic quality score is calculated according to the traffic sub-data and the weight includes that: a webpage traffic quality score F of each webpage URL is calculated by using a formula: F=Q*S, where, Q is the weight, and S is the traffic sub-data; and the webpage traffic quality scores are sumd to obtain the traffic quality score of the target website. Wherein, pre-set dimension data may be a date, a region and the like.

For example, the total traffic quantity of January 1^{st} is equal to 11200 (traffic data) by summing 10000 hits to a homepage (traffic sub-data of the homepage), 1100 hits to a product page (traffic sub-data of the product page) and 100 hits to a payment page (traffic sub-page of the payment page).

After the traffic sub-data corresponding to a page URL, a product page URL and a payment page URL is extracted from the traffic data respectively, the total traffic quality is calculated. Namely, Fₜₒₜₐₗ=1*10000+5*1100+20*100=17500 hits. Similarly, the total traffic quantity of January 2^{nd} is equal to 11200 hits by summing 9000 hits to the homepage, 2000 hits to the product page and 200 hits to the payment page, and the total traffic quality is 1*9000+5*2000+20*200=23000.

According to the embodiment of the disclosure, after the traffic quality of the target website is determined in accordance with the pre-set dimension data, the traffic data and the weight, the method may further include that: the traffic quality corresponding to different dimension data is compared to generate a traffic quality analysis report.

In the illustration, after the traffic quality of different dates is acquired, the traffic quality can be analyzed and compared. Specifically, the sizes of traffic data corresponding to different dimension data are compared to obtain a comparison result, an association relation is established among the comparison result, the dimension data, a traffic data volume, the traffic quality and the page URL, and the data and the association relation thereof are saved in a data table to generate the traffic quality analysis report.

In the embodiment of the disclosure, the total traffic data of January 1^{st} and the total traffic data of January 2^{nd} are equal. In an analysis method in the traditional art, it will be determined that the traffic quality is equal, however, actually, an owner of an e-commerce website gains different benefits on January 1^{st} and January 2^{nd}, and the traffic quality scores of January 1^{st} and January 2^{nd} are compared to obtain a conclusion that the traffic quality of the second day is higher.

In the embodiment of the disclosure, the traffic quality can be taken as a comparison reference for multiple dates or traffic conditions of all dimensions of different traffic sources, different regions and the like.

For example, a weight value of a URL1 is 1, a weight value of a URL2 is 10, and a weight value of a URL3 is 20. By means of the dimensions of the region (which may be a province specifically), it is analyzed that: if the traffic quantity of an access URL1 of Beijing is 100, the traffic quantity of a URL2 is 10 and the traffic quantity of a URL3 is 5, a traffic quality score of Beijing is calculated to be 300; and if the traffic quantity of an access URL1 of Shanghai is 10, the traffic quantity of a URL2 is 20 and the traffic quantity of a URL3 is 10, a traffic quality score of Shanghai is calculated to be 410.

Then, the traffic quality score of Beijing and the traffic quality score of Shanghai are compared to obtain a conclusion that the traffic quality of Shanghai is higher than that of Beijing. However, the method in the traditional art is adopted to obtain a conclusion that the access traffic of Beijing is 115 and the access traffic of Shanghai is 40, and therefore the analysis is inaccurate.

Specifically, traffic data of each webpage in a website can be collected by using a javascript and is stored in a form of a log file. Wherein, the traffic data contains each page URL of the website; optionally, the traffic data in the embodiment may further include: a traffic quantity and a weight value of each page URL; and furthermore, the traffic data may further include the dimension data, the dimension data may be one of regional dimensions, operating system dimensions of a user device viewing a target website, and browser dimensions for viewing the target website, or may be a combination of some dimensions, and extension and combination can be carried out according to an actual analysis requirement specifically.

The regional dimensions can be specifically divided into Beijing, Shanghai and other cities; the operating system dimensions of the user device can include Windows XP, Win7, Win8 and the like; and the browser dimensions include IE8, IE9, Firefox, Chrome and the like.

By means of the embodiment, if the regional dimensions are analyzed, it is necessary to access an IP address of a URL; if the operating system dimensions are analyzed, an operating system and a version number of the user device are needed; and if the browser dimensions are analyzed, a browser name and a version number are needed.

In the embodiment, assignment is carried out (namely the weight is determined) according to an importance difference between important URLs. Specifically, different target websites have different manual settings, a key page to which a site owner most expects a user to have access is found by carrying out service analysis on the target website, and higher weight values can be assigned to these pages; or by analyzing historical data of the target website, a relevancy between each page and a service target (such as an order quantity or an order amount), and a high value is assigned to a page having high relevancy.

The weight of the page URL in the embodiment can be pre-saved in the pre-set weight database.

After the weight of the page URL is determined, the traffic quality can be judged according to different dimensions.

It is important to note that the steps shown in the flowchart of the drawings can be executed in a computer system including, for example, a set of computer executable instructions. Moreover, although a logical sequence is shown in the flowchart, the shown or described steps can be executed in a sequence different from the sequence here under certain conditions.

From the above descriptions, it can be seen that the disclosure achieves the technical effects as follows. By means of the disclosure, the weight of the webpage URL in the target website is determined, and the traffic quality of the website is determined according to the pre-set dimension data, the traffic data and the weight. Different weight settings are made for different types and different levels of page URLs of the website instead of evaluation of strength and weakness of website traffic only in accordance with a traffic quantity, and different traffic quality scores are acquired accordingly. Thus, more effective traffic is enabled to have a higher traffic quality score, thereby solving the problem in the traditional art that the website traffic cannot be accurately analyzed by using traffic data, and achieving the effect of clearly, visually and accurately reflecting the degree of strength and weakness of the website traffic.

Obviously, those skilled in the art should understand that all modules or all steps in the disclosure can be realized by using a general calculation apparatus, can be centralized on a single calculation apparatus or can be distributed on a network composed of a plurality of calculation apparatuses. Optionally, they can be realized by using executable program codes of the calculation apparatuses. Thus, they can be stored in a storage apparatus and executed by the calculation apparatuses, or they are manufactured into each integrated circuit module respectively, or a plurality of modules or steps therein are manufactured into a single integrated circuit module. Thus, the disclosure is not limited to a combination of any specific hardware and software.

The above is only the preferred embodiments of the disclosure, and is not intended to limit the disclosure. There can be various modifications and variations in the disclosure for those skilled in the art. Any modifications, equivalent replacements, improvements and the like within the spirit and principle of the disclosure shall fall within the protection scope of the disclosure.

1. A traffic quality analysis method, comprising:
acquiring traffic data of a target website;
extracting a webpage Uniform Resource Locator (URL) from the traffic data;
determining a weight of the webpage URL; and
determining traffic quality of the target website in accordance with pre-set dimension data, the traffic data and the weight.

2. The traffic quality analysis method according to claim 1, wherein determining the weight of the webpage URL comprises:
extracting a pre-set weight value corresponding to the webpage URL from a pre-set weight database; and
assigning the pre-set weight value to the webpage URL to obtain the weight.

3. The traffic quality analysis method according to claim 1, wherein determining the traffic quality of the target website in accordance with the pre-set dimension data, the traffic data and the weight comprises:
extracting traffic sub-data corresponding to the dimension data from the traffic data; and
calculating a traffic quality score according to the traffic sub-data and the weight.

4. The traffic quality analysis method according to claim 3, wherein calculating the traffic quality score according to the traffic sub-data and the weight comprises:
calculating a webpage traffic quality score F of each webpage URL by using a formula: F=Q*S, wherein, Q is the weight, and S is the traffic sub-data; and
summing the webpage traffic quality scores to obtain the traffic quality score of the target website.

5. The traffic quality analysis method according to claim 1, wherein after the traffic quality of the target website is determined in accordance with the pre-set dimension data, the traffic data and the weight, the traffic quality analysis method further comprises:
comparing the traffic quality corresponding to different dimension data to generate a traffic quality analysis report.

6. A traffic quality analysis apparatus, comprising:
an acquisition module, configured to acquire traffic data of a target website;
an extraction module, configured to extract a webpage URL from the traffic data;
a weight determination module, configured to determine a weight of the webpage URL; and
a quality acquisition module, configured to determine traffic quality of the target website in accordance with pre-set dimension data, the traffic data and the weight.

7. The traffic quality analysis apparatus according to claim 6, wherein the weight determination module comprises:
a weight extraction module, configured to extract a pre-set weight value corresponding to the webpage URL from a pre-set weight database; and
an assignment module, configured to assign the pre-set weight value to the webpage URL to obtain the weight.

8. The traffic quality analysis apparatus according to claim 6, wherein the quality acquisition module comprises:
a data extraction module, configured to extract traffic sub-data corresponding to the dimension data from the traffic data; and
a calculation module, configured to calculate a traffic quality score according to the traffic sub-data and the weight.

9. The traffic quality analysis apparatus according to claim 8, wherein the calculation module comprises:
a first calculation sub-module, configured to calculate a webpage traffic quality score F of each webpage URL by using a formula: F=Q*S, wherein, Q is the weight, and S is the traffic sub-data; and
a second calculation sub-module, configured to sum the webpage traffic quality scores to obtain the traffic quality score of the target website.

10. The traffic quality analysis apparatus according to claim 6, further comprising:
a comparison module, configured to compare the traffic quality corresponding to different dimension data to generate a traffic quality analysis report.

11. The traffic quality analysis method according to claim 2, wherein after the traffic quality of the target website is determined in accordance with the pre-set dimension data, the traffic data and the weight, the traffic quality analysis method further comprises:
comparing the traffic quality corresponding to different dimension data to generate a traffic quality analysis report.

12. The traffic quality analysis method according to claim 3, wherein after the traffic quality of the target website is determined in accordance with the pre-set dimension data, the traffic data and the weight, the traffic quality analysis method further comprises:
comparing the traffic quality corresponding to different dimension data to generate a traffic quality analysis report.

13. The traffic quality analysis method according to claim 4, wherein after the traffic quality of the target website is determined in accordance with the pre-set dimension data, the traffic data and the weight, the traffic quality analysis method further comprises:
comparing the traffic quality corresponding to different dimension data to generate a traffic quality analysis report.

14. The traffic quality analysis apparatus according to claim 7, further comprising:
a comparison module, configured to compare the traffic quality corresponding to different dimension data to generate a traffic quality analysis report.

15. The traffic quality analysis apparatus according to claim 8, further comprising:
a comparison module, configured to compare the traffic quality corresponding to different dimension data to generate a traffic quality analysis report.

16. The traffic quality analysis apparatus according to claim 9, further comprising:
a comparison module, configured to compare the traffic quality corresponding to different dimension data to generate a traffic quality analysis report.
